(19) United States
(12) Patent Application Publication
(10) Pub. No.: US 2024/0375868 A1
(43) Pub. Date: Nov. 14, 2024

(54) A CAM MECHANISM FOR A DIRECTION-CHANGE ASSEMBLY OF A LOAD HANDLING DEVICE, AND RELATED METHODS AND USES

(71) Applicant: OCADO INNOVATION LIMITED, Hatfield, Hertfordshire (GB)

(72) Inventors: Måns Fredrik Jonathan NILSSON, Hatfield, Hertfordshire (GB); Matthew WHELAN, Hatfield, Hertfordshire (GB); Wilhelm Karl JOHANNISSON, Hatfield, Hertfordshire (GB)

(73) Assignee: OCADO INNOVATION LIMITED, Hatfield, Hertfordshire (GB)

(21) Appl. No.: 18/686,930

(22) PCT Filed: Aug. 25, 2022
(86) PCT No.: PCT/EP2022/073670

§ 371 Date: Feb. 27, 2024

(30) Foreign Application Priority Data
Aug. 27, 2021 (GB) 2112308.8

(51) Int. Cl. B65G 1/04; B65G 1/06

(52) U.S. Cl. CPC B65G 1/0464; B65G 1/0478; B65G 1/065

(57) ABSTRACT

A load handling device, method and kit of parts for a load handling device are disclosed. The load handling device includes a skeleton having a frame defining a volume having an upper portion, a lower portion, and a middle halo; a first set of wheels arranged on the lower part of the skeleton and a second set of wheels arranged on the lower part of the skeleton; and a direction-change assembly arranged to raise or lower the first set of wheels with respect to the skeleton, and or lower or raise the second set of wheels with respect to the skeleton to engage and disengage the first and second sets of wheels with parallel tracks, the direction-change assembly being located between the middle halo and the first set of wheels and or the second set of wheels, and wherein the direction-change assembly includes a cam mechanism.

### FIELD OF THE INVENTION

The present invention relates to arrangements for a direction-change assembly. More specifically but not exclusively, the invention relates to a cam mechanism.

### BACKGROUND

Robotic load-handling devices are described in UK Patent Application No. GB2520104A (Ocado Innovation Limited). Such load-handling devices are controllably moved on a track system forming a grid above stacks of bins or containers. A given load-handling device lifts a target container from the top of a stack, the target container containing inventory items needed to fulfil a customer order. The load-handing device comprises a first set of wheels and a second set of wheels for engaging with the x-direction track and the y-direction track respectively. For moving in the x-direction, the x-direction wheels are engaged with the track, while the y-direction wheels are raised. Similarly, for moving in the y-direction the y direction wheels are engaged with the track while the x-direction wheels are raised. The transition between x- and y-direction movements is controlled by a direction-change mechanism.

Mechanisms for enabling lateral movement of load-handling devices in transverse directions by selectively engaging the x-direction wheels or the y-direction wheels are described in WO2017153583A1 (Ocado Innovation Limited).

It is essential that a direction-change mechanism is robust, reliable and able to support the weight of the load-handling device and a target container, and that it is able to withstand repeated use.

It is against this background that the invention was devised.

### SUMMARY OF THE INVENTION

Aspects of the invention are set out in the accompanying claims.

One aim is to provide a lightweight load handling device. Another aim is to provide a low cost load handling device. Another aim is to provide a module load handling device, which is easy and or cheap to assemble and maintain. Another aim is to provide a load handling device that is primarily made from recyclable or environmental-friendly materials.

In one aspect of the invention, a load handling device for lifting and moving storage containers stacked in a grid based storage system framework structure is provided. The framework structure comprises: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load handling device comprises: a skeleton comprising a frame defining a volume having an upper portion, a lower portion, and a middle halo between the upper portion and the lower portion; a first set of wheels arranged on the lower part of the skeleton and a second set of wheels arranged on the lower part of the skeleton, the first set of wheels being arranged to engage with the first set of parallel tracks and the second set of wheels being arranged to engage with the second set of parallel tracks; and a direction-change assembly arranged to raise or lower the first set of wheels with respect to the skeleton, and or lower or raise the second set of wheels with respect to the skeleton to engage and disengage the first and second sets of wheels with the parallel tracks, the direction-change assembly being located between the middle halo and the first set of wheels and or the second set of wheels, and wherein the direction-change assembly comprises a cam mechanism.

The storage system may be an automated or semi-automated storage and retrieval system. The grid based storage system framework structure may be a high density cubic storage system. The load handling device, or bot, may be an autonomous or semi-autonomous device operating on the grid.

On the load handling device, the first set of wheels and the second set of wheels may be independently driveable with respect to each other. When the load handling device is being driven, only one set of wheels is engaged with the grid thereby enabling movement of the load handling device along the tracks to any point on the drive by driving the set of wheels engaged with the tracks. The direction-change assembly enables selection of the wheels engaged with the track.

It will be appreciated that engagement and disengagement with the tracks of the first set of wheels or the second set of wheel requires a vertical movement of the set of wheels in question, while the other set of wheels supports the load handling device.

The skeleton may be considered to be the body of the load handling device, and may be substantially without cladding or sides. For convenience, it may be useful to consider the skeleton in parts where the upper portion may be used to support or house components such as battery, communications, control systems, and motors, the lower portion primarily for the drive system and may be substantially empty space for receiving containers. The middle halo connects the lower portion and the upper portion and may provide additional stiffness to the skeleton.

Turning to considering the direction-change assembly, generally a cam, or linear cam, is a simple mechanism for transferring a linear input is transformed into a different motion. A cam profile may be formed on one or more edges or surfaces and may comprise slots, grooves or a surface profile. Accordingly, a cam may be arranged to convert a horizontal motion to a vertical motion by comprising vertical and horizontal elements.

The cam mechanism may allow reliable engagement between the selected set of wheels and the track.

The cam mechanism profile may have no discontinuities, for example, the cam profile may be shaped to provide a sinusoidal acceleration profile. In this way, the transition between engagement and disengagement may be smooth or jerk free. Further, the transition, may require a smooth force input.

The location of the direction-change assembly between the middle halo and the sets of wheels i.e. within the lower portion of the skeleton, may mean that the transfer of force from the direction-change assembly to the wheels is substantially direct i.e. without long linkages which are likely to lead to mechanical losses, at least in part due to bending moments and torques.

It will be appreciated, the cam path or profile may directly relate to the necessary vertical movement to engage and disengage the wheels from the tracks. Accordingly, a cam mechanism based direction-change assembly may be vertically compact. As a result, the direction mechanism may be positioned so that it does not extend vertically beyond the middle halo, and may be substantially shorter than the vertical height of the middle halo. This allows more flexibility in positioning other components of the load handling device. For example, reduction in the height of the direction-change assembly may allow for the middle halo to be widened, thereby increasing the overall stiffness of the skeleton. Further, reduction in height may enable the centre of mass of the load handling device to be kept as low as possible thereby improving stability of the load handling device, particularly when operating on the grid.

It will be appreciated that a horizontally mirrored cam profile may be required for the y-direction sides of the load handling device, compared with the x-direction sides of the load handling device.

It will be appreciated that as a cam is a relatively simple mechanical device, the number of parts necessary for the direction-change assembly may be kept to a minimum. With fewer parts, advantageously the direction-change assembly may have improved tolerances. It will be understood that typically, as the number of parts increases it is necessary to more accurately manufacture parts to ensure that they fit together, or to ensure that the overall tolerance of an assembly does not become unacceptable.

The cam mechanism may comprise: a traveller; a fixed brace, wherein the traveller is arranged to move relative to the fixed brace under an applied horizontal force; a cam; and a follower, wherein the follower is engageable with the cam to convert movement of the traveller to a vertical movement.

It will be appreciated that these may be typical components of a cam mechanism.

The follower may be attached to the fixed brace and the cam is connected to the traveller, OR the follower may be attached to the traveller and the cam is connected to the fixed brace.

It will be appreciated that either arrangement may result in an equivalent transfer of horizontal motion to vertical motion. It will be appreciated, that a vertically mirrored cam profile may be required depending on which arrangement is selected.

The fixed brace may comprise a wheel chassis for mounting a pair of respective first set of wheels or second set of wheels.

The wheels may be fixed directly or substantially directly to the direction-change assembly. In this way, no additional components are required and mechanical losses between the direction-change assembly and the wheels may be minimised.

The fixed brace may be constrained by one or more mountings to the skeleton to move only in a vertical direction.

In this way, out of plane vertical movement of the cam mechanism and or the wheel chassis may be prevented to ensure that substantially all horizontal input is used for conversion into vertical movement for engaging and disengaging the wheels.

The cam may be a linear cam. The cam may comprise a slot, OR the cam may comprise a surface.

It will be appreciated, that a linear type cam may be arranged to follow a single edge such as a surface, or the follower may be constrained between two edges such as a slot.

A slot arrangement may have the advantage of ensuring that the follower continues to follow the cam profile in both forward and reverse directions.

The follower may comprise a roller or slider, supported by a cover.

In the case of a sliding cam, the follower may be a rigid protrusion without any degrees of freedom. Frictional loses between the follower and the cam may be reduced by low friction material selection, or by using a lubricant.

In the case of a roller or rolling means, the follower may comprise a bearing.

The follower may be supported by covers on respective sides.

It will be appreciated that holding the follower between two covers may allow a slight compression force to be imposed on the follower. This may assist in keeping the follower in vertical alignment with the cam.

The cam mechanism may comprise a single cam arrangement or the cam mechanism may comprise a double cam arrangement.

The cam mechanism may comprise engagement means between the traveller and the fixed brace. For example, the traveller may comprise engagement feet to engage with a corresponding plinths on the fixed brace, or wheel mount. Typically the feet will be arranged to engage with the plinths when in a drive position. The engagement between the feet and plinths provides increased rigidity to the side. Increased rigidity may increase stability and controllability of the load handling device. Such an arrangement may be particularly useful in a single cam arrangement.

In a double cam arrangement, the cam mechanism may comprise two linked horizontally spaced apart cam surfaces and corresponding followers on the traveller and fixed brace. In this way, each of a pair of wheels may have a corresponding cam. This may provide advantages to ensure better balance and or support of the wheel base or chassis because the pair of wheels will be lifted and lowered at two points. It will be understood that this may reduce any rotation of the wheel base.

The cam mechanism may comprise a triple cam arrangement.

It will be appreciated that any number of cam arrangements may be provided across a side of a device.

A triple cam arrangement may be advantageous where the load handling device is heavier and the wheels support a greater load. It will be appreciated that the load may be spread across each of the cams.

The cam mechanism may be arranged in a single vertical plane between the middle halo and a respective pair of wheels.

It will be understood, that the traveller, fixed brace, cam and follower may be in the same vertical plane. In this way, the cam mechanism may only occupy the horizontal space required for the width or depth of the components. Accordingly, the horizontal space required may be minimised, and as a result may substantially maximise the empty volume of the skeleton. Maximising the horizontal available space of the load handling device may be important for grid based storage systems where the system is designed such that a load handling device occupies substantially only a single grid space to allow other load handling devices operating on the grid to pass on adjacent grid spaces, and thereby maximise efficiency of the system.

In this way, the cam mechanism may substantially comprise the side face of the skeleton structure. It will be appreciated, that other components may also be present on the side face of the skeleton, however, the skeleton may remain substantially open.

Respective pairs of the first set of wheels and the second set of wheels may be driven by a drive belt, and the cam mechanism may be located within an area defined by the path of the drive belt.

In this way, the cam mechanism may substantially intermesh, interlace or overlap with other systems of the load handling device. It will be appreciated, that the arrangement may reduce the necessary volume within the skeleton for components and systems.

The cam mechanism may further comprise a spring means between the traveller and the fixed brace.

The spring means may assist in biasing the fixed brace into a preferred vertical position. For example, the spring means may bias the traveller and fixed brace together against the effects of gravity. Such an arrangement may be particularly useful where the cam comprises a single edge or surface rather than a slot. In this way, the spring means may ensure that the follower remains substantially engaged with the cam profile.

A first limit of the cam mechanism may define a raised wheel position, and a second limit of the cam mechanism may define a lowered wheel position.

It will be appreciated that the cam profile may extend between a first limit and a second limit. For example, where the cam profile is a slot, the first limit may be a first end of the slot, and the second limit may be the distal end of the slot. In the case of a single sided surface or edge, the cam profile may be limited with a protrusion or discontinuity.

During use, the follower may have freedom to move between the first limit and the second limit. In employing the cam mechanism as part of a direction-change assembly, the first limit may correspond to a wheels raised or wheels up position, and the second limit may correspond to a wheels down or lowered position. In the raised position the wheels may be disengaged or clear of the track and in the lowered position the wheels may be engaged with the track.

The direction-change assembly may be arranged to raise or lower the first set of wheels and synchronously, respectively, lower or raise the second set of wheels with respect to the skeleton.

In order for the load handling device to move in the x-direction or the y-direction on the grid, it may be necessary to have only one set of wheels engaged with the tracks. Accordingly, it may be advantageous to raise the first set of wheels at substantially the same time as lowering the second set of wheels, and vice versa.

In other arrangements, it may be advantageous to ensure that the load handling device is supported throughout the transition between engagement of the first set of wheels or the second set of wheels. In this way, when changing from the first set of wheels to the second set of wheels, the first set of wheels are maintained in a lowered position while the section set of wheels are lowered. Once the second set of wheels is engaged with the tracks, the first set of wheels are raised. Accordingly, the centre of gravity of the bot is maintained throughout the direction-change operation and the direction change motor is not required to work against the weight of a carried load.

Respective cam mechanisms may be mechanically connected to move in unison between wheel up and wheel down configurations.

It will be appreciated that the direction-change assembly may comprise a respective cam mechanism for each pair of wheels, arranged on each side of the load handling device. By mechanically linking the respective cam mechanisms it may be possible to substantially coordinate vertical movement of the first set of wheels and the second set of wheels. Further, it may be possible to operate the vertical movement with a single actuation.

The mechanical connection or linkage may be a belt or chain. The belt may be routed substantially around the circumference of the skeleton and attached to traveller of respective cam mechanisms. In this way, when the belt is rotated or driven, the travellers move together to provide a horizontal input to the cam mechanism. A belt arrangement may be relatively cheap and relatively light weight.

In another arrangement, the mechanical connection may be a lead screw arranged on each side of the load handling device. Each screw may be connected by 90 degree bevel gears. Such an arrangement may be used without a gearbox, as the gearing may be provided by the pitch of the screw. Screws on opposed sides of the load handling device could be arranged to operate in the same direction, or screws on opposed sides could be arranged to operate in opposed directions.

The direction-change assembly me be operated by a single motor, OR wherein the direction-change assembly may be operated by more than one motor.

In this way, a single motor may be used to change the direction of movement of a load handling device. It will be appreciated that a motor may be replaced with any means of activation, for example, a solenoid, hydraulic means, pneumatic means, servo means, solid state actuation means etc. Advantageously this may reduce the overall cost and weight of the load handling device.

Where more than one motor is used, the load handling device may have some redundancy so that the load handling device may continue to operate even when there is partial failure of the load handling device, and thus avoid complete failure of the maneuverability of the load handling device on the grid. Advantageously, a more robust direction change mechanism is provided. Advantageously, this reduces the downtime of individual load handling devices, and the overall storage and retrieval system.

A load handling device may further comprise sensing means for determining engagement of the first set of wheels or second set of wheels with the parallel tracks.

Accordingly, proper function of the direction-change assembly may be detected.

A load handling device may further comprise sensing means for determining malfunction or failure of the direction change assembly.

In the case of a malfunction of the direction-change assembly, if a single set of wheels are engaged with the tracks, then the load handling device may move to the edge of the grid for recovery and repair. In the case where the load handling device is unable to move, a communication for recovery and repair could be communicated to a control facility of the storage system.

At least a part of the cam mechanism may be 3-D printed, AND OR at least a part of the cam mechanism may be substantially topologically optimised.

In this way, it may be possible to realise forms or complex shapes which are not possible to realise with more traditional types of manufacturing. Advantageously, the cam mechanisms may be printed on-demand or at a 3-D printing facility that is near to the location where the part is required, thereby minimising logistical costs in getting parts to where they are required. It will be appreciated that 3-D printing referred to herein could be more generally referred to as additive manufacturing, involving layer on layer of addition of material.

It may be possible to print parts comprising more than one type of material. In this way, some areas may have lower friction for sliding or rolling efficiency, while other areas may have material with properties selected for stiffness and strength. Accordingly, the cam mechanisms may be load bearing and may comprise a portion of a complex part. For example, the cam mechanism and chassis and other side features may be printed as a single part.

It may be possible to print more than one part of the cam mechanism together as a single print with multiple parts. In this way, faults in tolerance between parts may be minimised.

The cam mechanism may be substantially topologically optimised. In this way, the cam mechanism may be optimised to reduce the total amount of material used and therefore mass. Alternatively, the cam mechanism may be optimised to remain within certain stress limits to ensure that the cam mechanism operates below fatigue limit within the operating temperature range.

The load handling device may further comprise: a lifting device supported by the upper portion of the skeleton, for lifting containers into the volume.

Accordingly, a load handling device may be used to retrieve storage containers.

The load handling device may further comprise means for sensing position on the grid. The load handling device may further comprise means for lifting storage containers. The load handling device may further comprise means for transporting lifted storage containers to a position on the grid. The load handling device may further comprise means for identifying storage containers. The load handling device may further comprise means for identifying a storage container. The load handling device may be movable autonomously, without continual direction from the centralised control utility. The load handling device may be remotely manoeuvrable under the control of a storage system. The load handling device may further comprise means for communicating a signal to a centralised control utility and may be movable under control of the centralised control utility. The load handling device may further comprise means for powering the direction change assembly. The load handling device may further comprise a drive assembly. The load handling device may have belt driven wheels. The load handling device may further comprise identification means.

In another aspect, a method of changing the engagement of sets of wheels with a track, of a load handling device according to any preceding claim, where the load handling device operates on a grid framework (14) structure comprising tracks is provided. The method comprising the steps of: applying a force to the traveller of the direction-change assembly in a first direction F₁, causing cam mechanism to move to a first limit, OR applying a force to the traveller of the direction-change assembly in a second direction F₂, causing cam mechanism to move to a second limit.

In another aspect, a kit of parts for modular assembly of a load handling device is provided. The kit comprising: a skeleton, a first set of wheels and a second set of wheels, wherein the skeleton may be mounted on the first set of wheel and the second set of wheels; and at least one direction-change assembly comprising at least one cam mechanism each cam mechanism having a traveller, a fixed brace, a follower and a cam pathway.

Accordingly, the load handling device may be substantially modular. Systems and parts of the load handling device may be substantially interchangeable.

The fit of parts may further comprise: at least two cam mechanisms and a transfer belt.

The fit of parts may further comprise: at least one direction change motor.

At least one part may be 3-D printed.

The fit of parts may further comprise at least one of: a set of wheels, a drive assembly, a gripper assembly, a lifting assembly, a communications system, AND/OR a sensor means.

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 illustrates a storage structure;

FIG. 2 illustrates a track structure;

FIG. 3 illustrates robotic load handling devices on top of the storage structure illustrated in FIG. 1;

FIG. 4 illustrates a robotic load handling device or bot;

FIG. 5 illustrates a robotic load handling device or bot;

FIG. 6 illustrates a load handling device and a direction-change assembly, where in FIG. 6a the load handling device is parked, in FIG. 6b the x-direction wheels are raised while the y-direction wheels are lowered for movement in the y-direction, and in FIG. 6c the y-direction wheels are raised while the x-direction wheels are lowered for movement in the x-direction;

FIG. 7 illustrates a direction-change cam mechanism;

FIGS. 8a-c illustrate the cam mechanism of FIG. 7 in lowered, parked and raised positions;

FIG. 9 illustrates a double cam mechanism;

FIGS. 10a-c illustrate the double cam mechanism of FIG. 9 in lowered, parked and raised positions;

FIG. 11 illustrates a triple cam mechanism;

FIGS. 12a-b illustrate inverted cam mechanisms: (a) where the follower is attached to the traveller and the cam is defined on the fixed brace, and (b) where the cam is defined on the traveller and the follower is attached to the fixed brace;

FIGS. 13a-c illustrate an edge or surface cam mechanism in lowered, parked and raised positions;

FIG. 14 illustrates an inverted version of the surface cam mechanism illustrated in FIG. 13;

FIG. 15 illustrates a side view of a cam and wheel mount arrangement;

FIG. 16 illustrates a front view of a cam and wheel mount arrangement;

FIGS. 17a-b illustrates cam mechanisms having anti-rotation feet: (a) has the cam attached to the traveller, and (b) has the cam attached to the fixed brace;

FIGS. 18a-f illustrate cam mechanisms having anti-rotation feet, with the traveller in different positions, similar to the cam mechanism illustrated in FIG. 17: FIGS. 18 (a)-(c) have the cam attached to the traveller, and FIGS. 18 (d)-(e) have the cam attached to the fixed brace; and

FIGS. 19a-f illustrate a difference between a cam mechanism having anti-rotation fee FIGS. 19 (a-c) and a cam mechanism without anti-rotation feet FIGS. 19 (d-f); when a bot is in motion and under acceleration FIGS. 19 (a, d), when a bot is in motion and no acceleration FIGS. 19 (b, e) and when a bot is in motion and under deceleration FIGS. 19 (c, f).

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

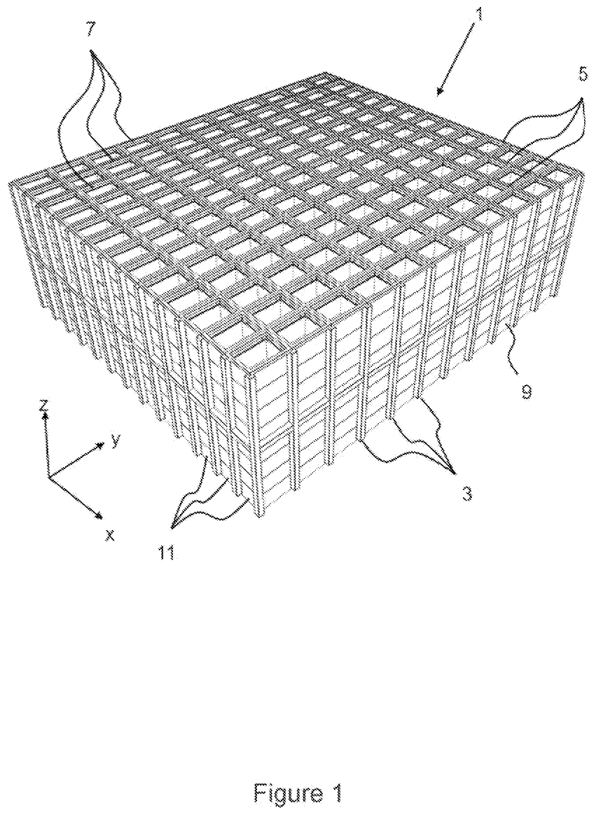

FIG. 1 illustrates a storage structure 1 comprising upright members 3 and horizontal members 5, 7 which are supported by the upright members 3. The horizontal members 7 extend parallel to one another and the illustrated x-axis, whereas the horizontal members 5 extend parallel to one another and the illustrated y-axis, transversely to the horizontal members 7. The upright members 3 extend parallel to one another and the illustrated z-axis. The horizontal members 5, 7 form a grid pattern defining a plurality of grid cells. In the illustrated example, containers 9 are arranged in stacks 11 beneath the grid cells defined by the grid pattern, with one stack 11 of containers 9 per grid cell.

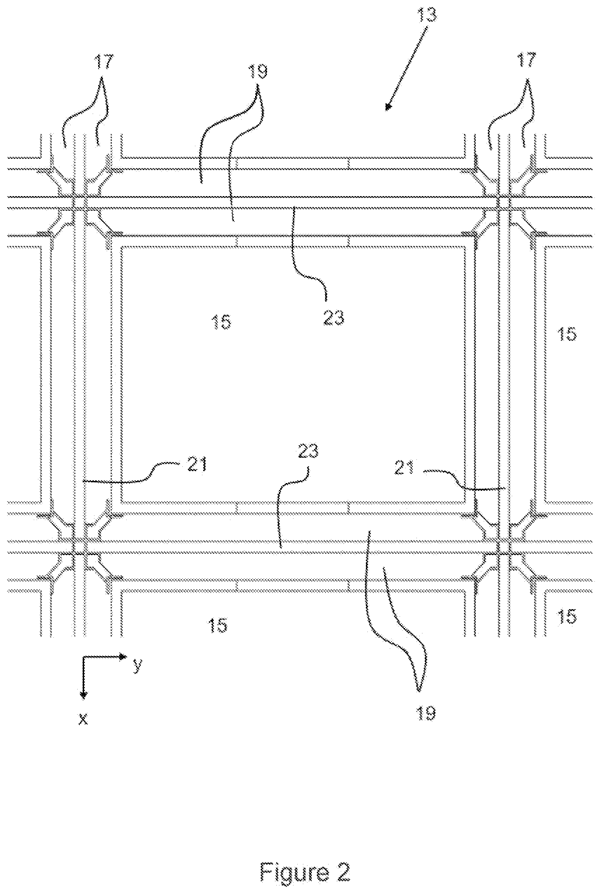

FIG. 2 shows a large-scale plan view of a section of a track structure 13, located on top of the horizontal members 5, 7 and forming part of the storage structure 1 illustrated in FIG. 1. The track structure 13 may be provided by the horizontal members 5, 7 themselves (e.g., formed in or on the surfaces of the horizontal members 5, 7) or by one or more additional components mounted on top of the horizontal members 5, 7. The illustrated track structure 13 comprises x-direction tracks 17 and y-direction tracks 19. In this case, a first set of tracks 17 extend in the x-direction and a second set of tracks 19 extend in the y-direction, transverse to the first set of tracks 17. The tracks 17, 19 define apertures 15 at the centres of the grid cells. The apertures 15 are sized to allow containers 9 located beneath the grid cells to be lifted and lowered through the apertures 15. The first set of tracks 17 are provided in pairs separated by ridges 21, and the second set of tracks 19 are provided in pairs separated by ridges 23. Other arrangements of track structure may also be possible.

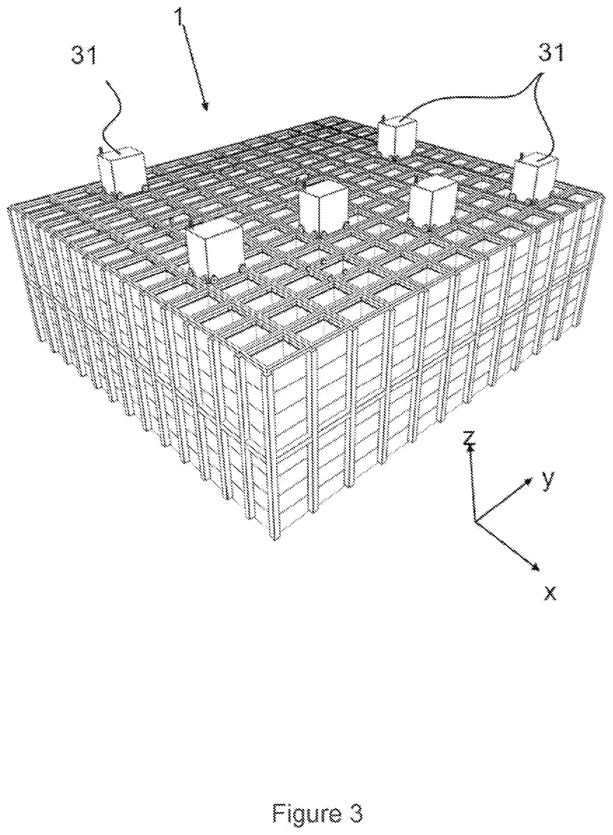

FIG. 3 shows a plurality of robotic load handling devices 31 moving on top of the storage structure 1 illustrated in FIG. 1. Each load-handling device 31, which may also be referred to as a robot 31 or bot 31, is provided with a direction-change assembly (not shown) and sets of wheels to engage with corresponding x- or y-direction tracks 17, 19 to enable the bot 31 to travel across the track structure 13 and reach specific grid cells. As mentioned, the sets of tracks 17, 19 are separated by ridges 21, 23 allowing a pair of bots 31 to occupy neighbouring grid cells or pass one another without colliding.

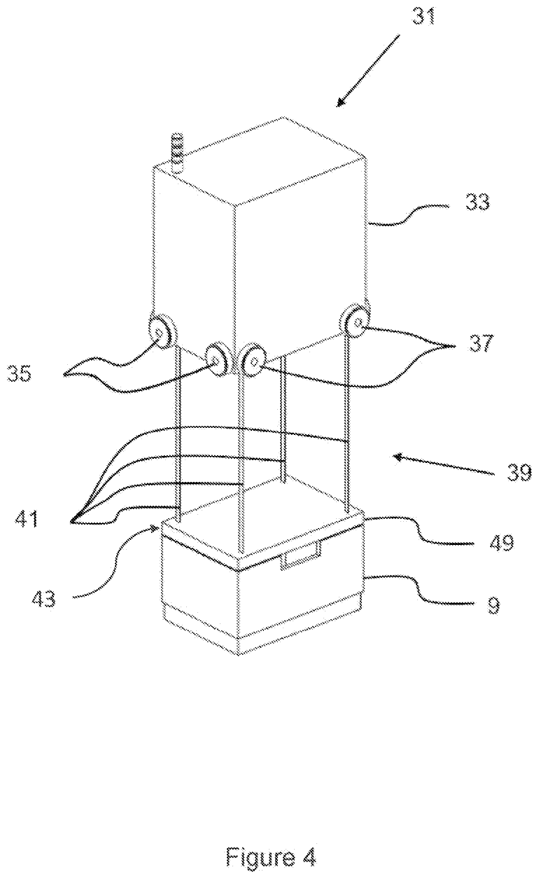

As illustrated in detail in FIG. 4, a bot 31 comprises a body 33 in or on which are mounted one or more components which enable the bot 31 to perform its intended functions. These functions may include moving across the storage structure 1 on the track structure 13, and lowering or raising containers 9 to or from the stacks 11 so that the bot 31 can deposit or retrieve containers 9 in specific locations defined by the grid pattern.

In order to perform the former function, the bot 31 comprises first and second sets of wheels 35, 37, which are mounted on the body 33 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side 36 of the bot 31. The wheels 35 are rotatably mounted on the body 33 and are configured to engage with tracks 17 to allow the bot 31 to move along the tracks 17. Analogously, two wheels 37 are provided on the longer side of the bot 31 visible in FIG. 4, and a further two wheels 37 are provided on the opposite longer side 38 of the bot 31. The wheels 37 engage with tracks 19 and are rotatably mounted on the body 33 of the bot 31 to allow the bot 31 to move along the tracks 19.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

In furtherance of the latter function, the bot 31 further comprises container-lifting means, generally designated by 39, configured to raise a container 9 from a stack 11 into a container-receiving space or cavity of the bot 31, and lower a container 9 from the container-receiving space onto a stack 11. The illustrated container-lifting means 39 comprises four tapes or reels 41 which are connected at their lower ends to a container-engaging assembly 43. The tapes 41 may be wound up or down to raise or lower the container-engaging assembly 43, as required. One or more motors or other means may be provided to effect or control the winding up or down of the tapes 41.

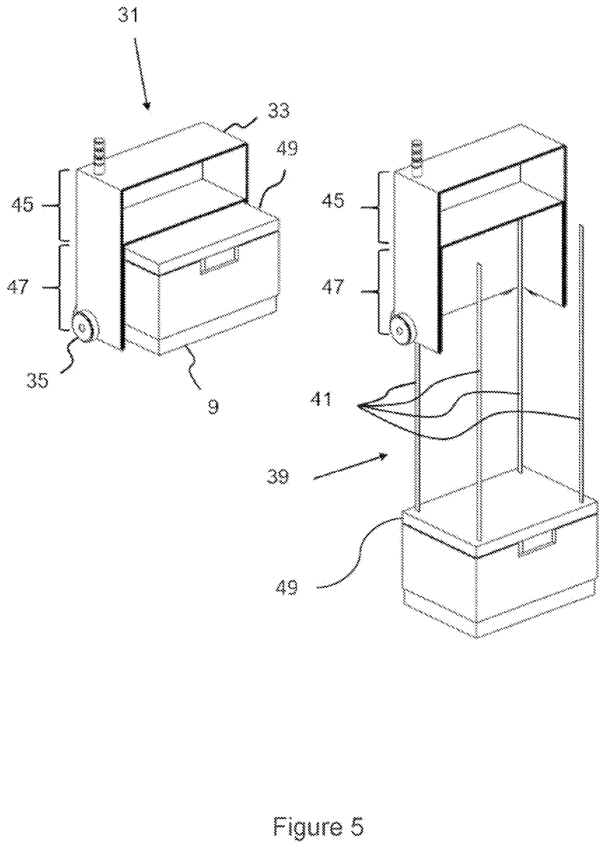

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45 and comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-engaging assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

It will be appreciated that while the load handling devices are described as a single (gird-) space bot (load handling device) as an example, the automated or semi-automated storage and retrieval systems are not limited to systems directed to using single space bots

In some embodiments, the container-receiving space of the bot 31 may not be within the body 33 of the bot 31. For example, in some embodiments, the container-receiving space may be adjacent to the body 33 of the bot 31 (e.g., in a cantilever arrangement with the weight of the body 33 of the bot 31 counterbalancing the weight of the container to be lifted). In such embodiments, a frame or arms of the container-lifting means 39 may protrude horizontally from the body 33 of the bot 31, and the tapes/reels 41 may be arranged at respective locations on the protruding frame and configured to be raised and lowered from those locations to raise and lower a container into the container-receiving space adjacent to the body 33. The height at which the frame is mounted on and protrudes from the body 33 of the bot 31 may be chosen to provide a desired effect. For example, it may be preferable for the frame to protrude at a high level on the body 33 of the bot 31 to allow a comparatively larger container or a plurality of containers to be raised into the container-receiving space beneath the frame. Alternatively, the frame may be arranged to protrude lower down the body 33 (but still high enough to accommodate at least one container between the frame and the track structure 13) to keep the centre of mass of the bot 31 lower when the bot 31 is loaded with a container.

In contrast to a cantilever bot, by arranging the bulky components of the load handling device above the container-receiving space, the footprint of the load handling device is reduced compared to the cantilever designs described in NO317366, in which the bulky components are housed in a vehicle module disposed to one side of the container-receiving space. Advantageously, the load handling device of the present invention occupies the space above a corresponding number of stacks in the frame as vehicle modules and containers to be lifted.

The single space load handling devices can also offer improved stability, increased load handling capacity and reduced weight compared to the cantilever-type prior art load handling devices, because in the invention the load of the containers is suspended between the pairs of wheels on each side of the vehicle.

In the embodiment shown in FIGS. 4 and 5, the container-engaging assembly 43 comprises a gripper plate 49 attached to the lower ends of the tapes 41 and one or more gripper assemblies (not shown) mounted thereon for latching to a container 9. The gripper assemblies, which may, for example, be provided at the corners of the gripper plate 49, in the vicinity of the tapes 41, are arranged to align with recesses or openings in the containers 9 and interact therewith when activated in order to latch to the containers 9.

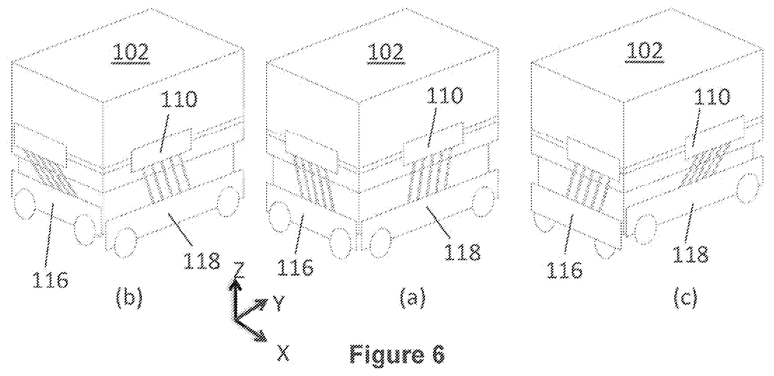

Turning to aspects of the wheel positioning mechanism or direction-change assembly in more detail, FIG. 6 illustrates a perspective view of a load handling device 102 having a direction-change assembly 110, in three positions: parked, y-direction movement and x-direction movement.

In FIG. 6a both the x-direction wheel chassis 116 and the y-direction wheel chassis 118 are down so that all the wheels would be engaged with the track if the load handling device were positioned on a grid structure as described above. In FIG. 6b, the x-direction wheel chassis 116 is raised while the y-direction wheel chassis 118 is lowered for movement in the y-direction, and in FIG. 6c the y-direction wheels chassis 118 is raised while the x-direction wheel chassis is lowered for movement in the x-direction. Each of the wheel chassis 116, 118 are moved vertically by connection to the direction-change assembly 110 as will be described in more detail below. The wheel chassis 116, 118 are at the same vertical or z-direction level in the parked position.

The direction-change assembly comprises a mechanism on each side face of the load handling device 102. In FIG. 6 a mechanism is shown on the visible x-direction side, and a similar mechanism is arranged on the opposing x-direction side (not shown). Similarly a mechanism is shown on the visible y-direction side, and a similar mechanism is arranged on the opposing y-direction side (not shown). Each linkage-set or direction-change assembly 110 is connected to the corresponding wheel chassis 116, 118 for the particular side.

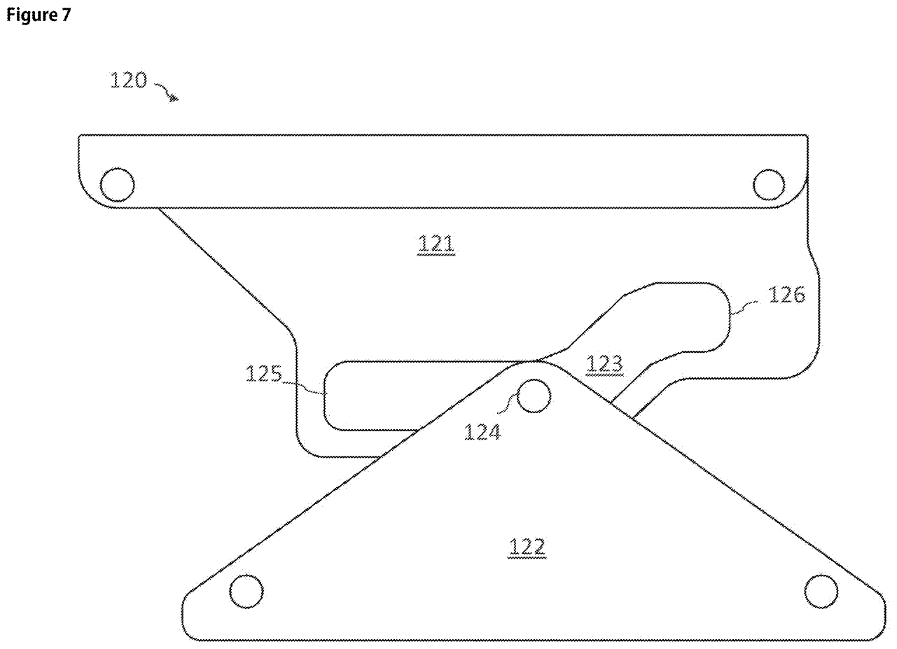

FIG. 7 illustrates a cam mechanism 120 for use in a direction-change assembly, for example, of the type described in connection with FIG. 6. The cam mechanism 120 comprises a traveller 121, a fixed brace 122, a cam profile 123 arranged as a slot in the face surface of the traveller 121 and a follower 124 engaged with the cam 123 and extending between opposed faces or covers of the fixed brace 122. It will be appreciated that the fixed brace 122 may be made from a single piece or block having a depth sufficient to have a slot to accommodate the depth of the traveller 121, and arranged to hold the follower 124 in place, or the fixed brace 122 could be made from two planes of material clamped together with the follower 124 fixed therebetween.

The cam or slot profile 123 extends between a first limit 125 and a second limit 126. Between the limits, as illustrated the slot extends from the first limit 125 substantially horizontally, slops upwards and then continues substantially horizontally to the second limit 126 with enough space to accommodate the follower 124.

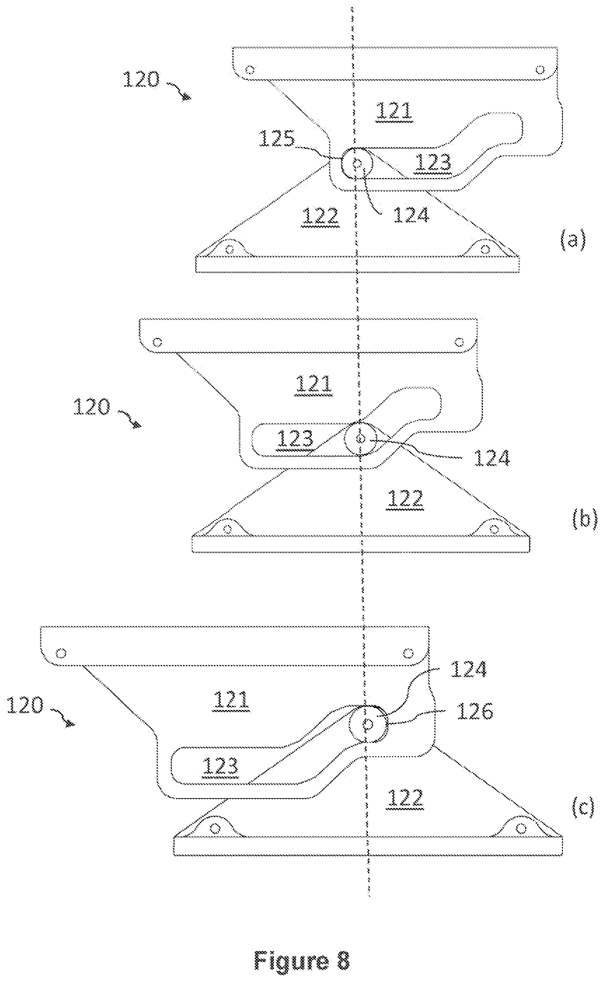

In a first arrangement of the cam mechanism 120 arrangement shown, the traveller 121 is able to move horizontally and is fixed in a vertical direction while the fixed brace 122 is fixed horizontally and is able to move vertically. Accordingly, as the cam 123 moves horizontally across the follower from the first limit 125 to the second limit 126 the fixed brace 122 will be raised by an amount equal to the vertical change in the cam profile 123. It will be appreciated that, alternatively in a second arrangement, the fixed brace 122 may be able to move horizontally while being fixed in a vertical direction and the traveller 121 may be fixed in the horizontally direction and able to move vertically. The relative positions between the traveller 121 and the fixed brace 122 according to the first arrangement are illustrated in FIG. 8, which shows the cam 120 in various positions.

FIGS. 8a-c illustrate the cam mechanism of FIG. 7 where the front face of the fixed brace 122 has been removed such that it is easier to see and understand the position of the follower 124. The vertical dotted line is positioned through the follower 124 to assist in the understanding of the relative position of the cam mechanism 120 between the views.

In FIG. 8a, the traveller 121 has been positioned horizontally to the right. The follower 124, which is connected to the fixed brace 122 is positioned at the first limit 125 of the cam 123.

In FIG. 8b, the traveller 121 has been positioned centrally, left of the position in FIG. 8a. From the position shown in FIG. 8a, the cam 123 has moved relative to the follower 124 such that the follower 124 is located at the first inflection point of the cam slot. The fixed brace 122 has not moved its position relative to its position in FIG. 8a.

In FIG. 8c, the traveller 122 has been positioned horizontally to the left. The cam 123 has moved relative to the follower 124 such that the follower 124 has had to move vertically to be up the slope to be located at the second limit 126. As the follower 124 is fixed to the fixed brace 122, and as the fixed brace 122 is fixed horizontally, necessarily, the fixed brace 122 is moved vertically. In FIGS. 8a and 8b the fixed brace 122 is in a lowered position relative to the traveller 121, while in FIG. 8c the fixed brace 122 is in a raised position relative to the traveller 121.

It will be appreciated that if a pair of wheels were fixedly attached to the fixed brace 122 then the cam mechanism 120 could be used to raise and lower the wheels as required by applying a horizontal force to the traveller 121. The position of the cam 120 shown in FIG. 8b could be used as a ‘park’ position, where the wheels are ready to be moved into engaged (FIG. 8a) or disengaged (FIG. 8c) positions.

It will be appreciated that the cam profile may be designed to provide any desired horizontal to vertical movement profile.

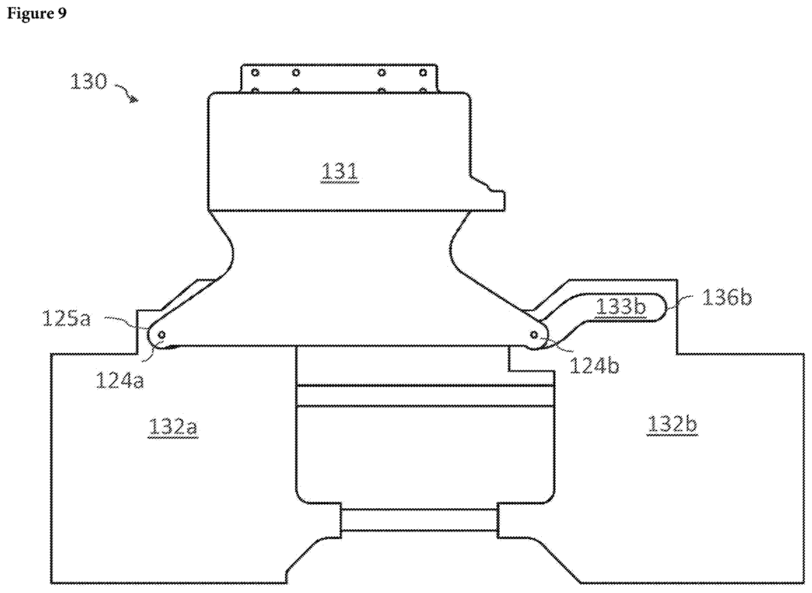

FIG. 9 illustrates another cam mechanism 130, employing a double cam arrangement. A first cam 133a and a second cam 133b are arranged horizontally adjacent. The first cam profile and the second cam profile 133b are substantially identical. Likewise, a pair of followers 124a and 124b are arranged to engage with the respective cams 133a, 133b.

This arrangement further differs from the arrangement shown in FIGS. 8a-c in that the first cam 133a and the second cam 133b are arranged on the fixed brace 132a, 132b while the first follower 124a and the second follower 124b are attached to the traveller 131, i.e. it is inverted. The fixed brace portions 132a and 132b are joined by a pair of bars.

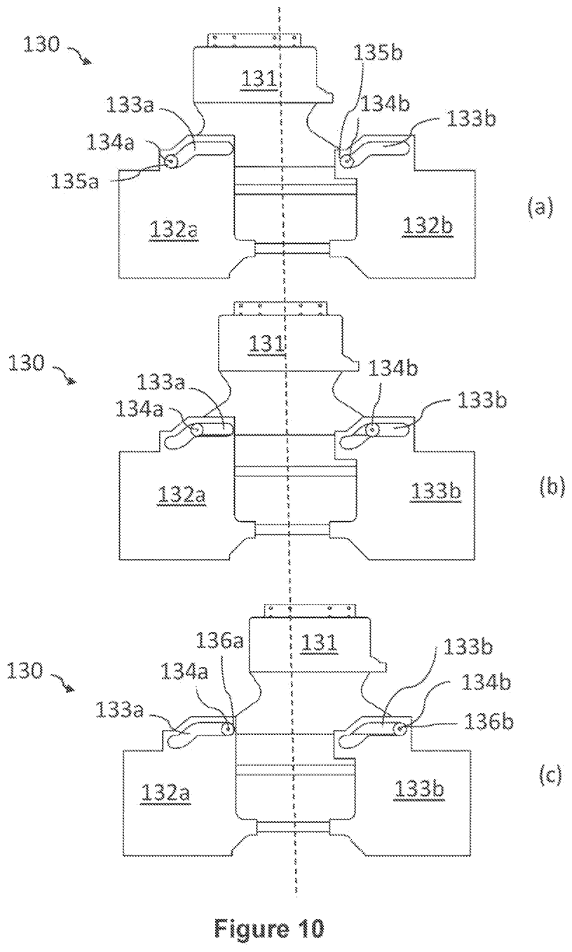

Operation of the cam mechanism 130 is similar to that of the cam mechanism 120. Where a horizontal force is applied to the traveller 131, the followers 124a and 124b move in unison along the first cam path 133a and the second cam path 133b respectively, between a first limit 125a, 125b and a second limit 136a, 136b. Assuming that the fixed brace 132a, 132b is restricted to only move in a vertical direction, horizontal movement of the traveller 131 results in the fixed brace 132a, 32b being raised and lowered, similarly to the function of the cam mechanism 120. FIGS. 10a-c illustrate the inverted double cam mechanism 130 in positions corresponding to the positions shown of the single cam mechanism 120 in FIGS. 8a-c respectively.

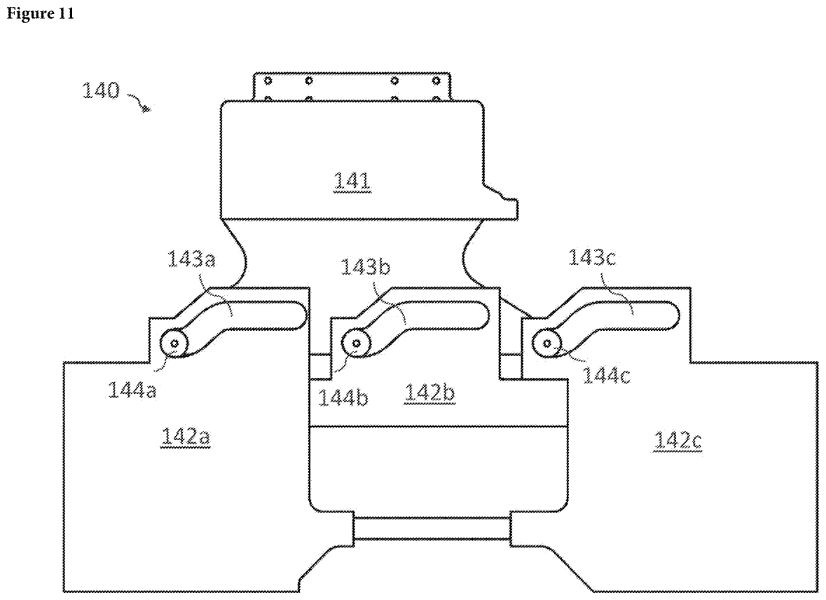

FIG. 11 illustrates another inverted cam mechanism 140, employing a triple cam arrangement. A first cam 143a and first follower 144a, a second cam 143b and a second follower 144b, and a third cam 143c and third follower 144c are arranged horizontally adjacently. Fix brace portions 142a, 142b, 142c are joined. Otherwise, arrangement of the triple cam mechanism 140 is similar to the double cam mechanism 130. Operation of the triple cam mechanism 140 is similar to that of the cam mechanisms 120, 130.

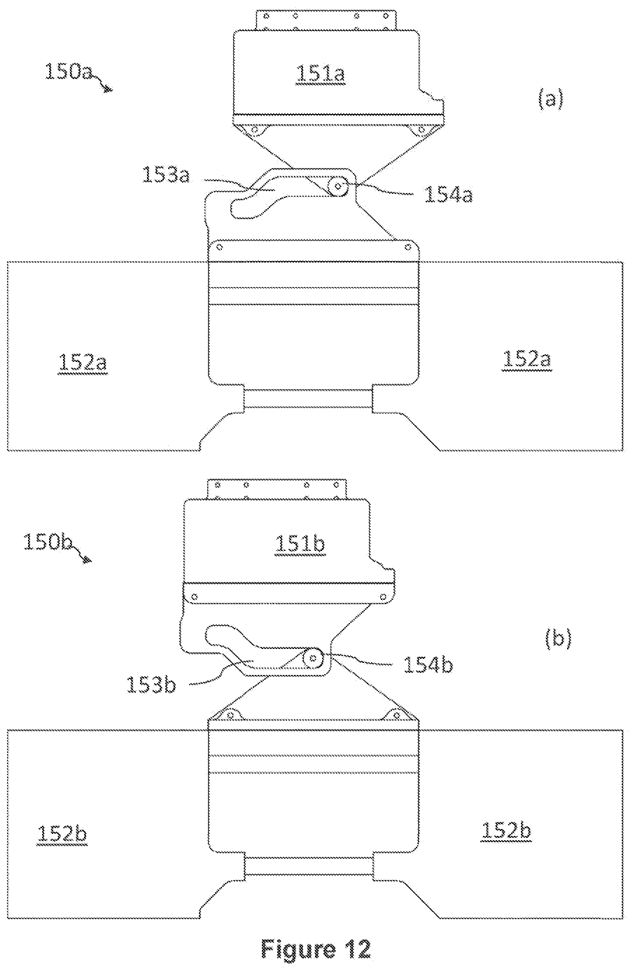

As discussed above, the cam profile may be defined on the traveller with the follower attached to the fixed brace (FIGS. 7 and 8) or the follower may be attached to the traveller where the cam profile defined on the fixed brace (FIGS. 9-11). Such inverted or ‘mirrored’ arrangements are shown in FIGS. 12a and 12b, where FIG. 12a is similar to FIGS. 9-11 and FIG. 12b is similar to FIGS. 7 and 8. It will be appreciated that a single cam mechanism has been shown for simplicity and this inversion or mirroring could apply to a cam mechanism with any number of similar cams (double, triple, etc.).

In FIG. 12 the cam mechanism 150a, 150b are arranged with a traveller 151a, 151b, a fixed brace 152a, 152b, a cam 153a, 153b and a follower 154a, 154b respectively. In FIG. 12a, the follower 154a is attached to the traveller 151a, and the cam 153a is defined on the fixed brace 152a, and vice versa for FIG. 12b. It will be appreciated, that the cam path 153a is a mirror reflection about an imaginary horizontal line compared with the cam path 153b in order to achieve the same vertical movement of the fixed braces 152a, 152b for a given horizontal input on the respective traveller 151a, 151b.

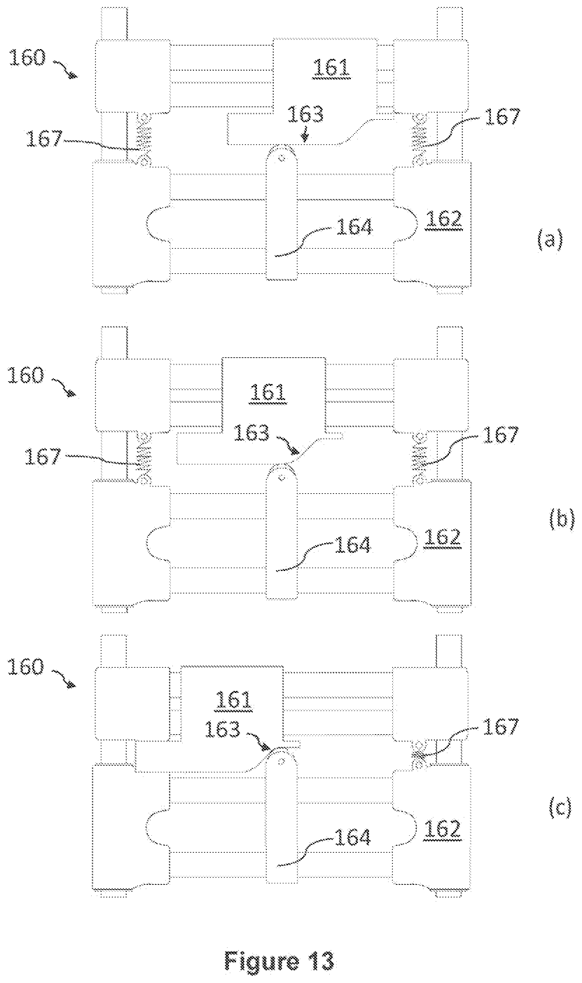

Another cam mechanism 160 arrangement is shown in FIGS. 13a-c. Unlike the previous cam mechanisms 120, 130, 140, 150, rather than the cam profile being defined by a slot, the cam profile is defined by the lower edge 163 of the traveller 161. The traveller 161 is able to move horizontally between corner blocks. The follower 164 is fixed in position on a fixed brace frame 162, and the fixed brace frame 162 is constrained to only vertical movement being glidingly mounted on vertical corner poles. Otherwise, the cam mechanism 160 operates similarly to the previous arrangements.

In the arrangement shown in FIG. 13, it will be appreciated, that when the follower 164 is in a position such that the fixed brace 162 would be raised relative to the traveller 161, the fixed brace 162 will tend to drop down due to gravity, thereby disengaging the follower from the cam surface or lower edge 163. Such tendency is mitigated against by the springs 167, which may be biased to draw the fixed brace 162 towards the traveller 161.

It will be appreciated that springs to bias the cam mechanism into a particular configuration may be employed on any of the previous arrangements.

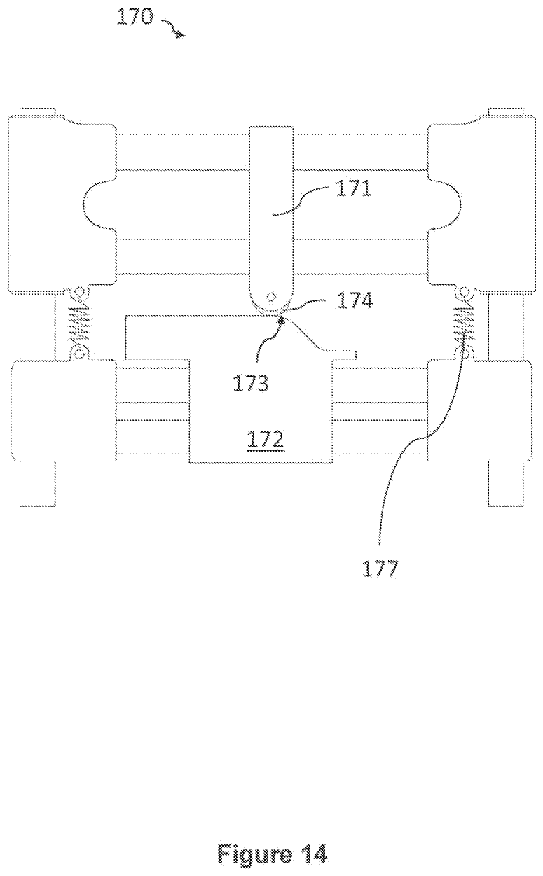

Again, like the examples discussed above, particularly in connection with FIGS. 12a and 12b, it will be appreciated that a surface or edge cam arrangement, may be arranged in a mirrored or inverted fashion relative to the arrangement shown in FIG. 13, as shown here in FIG. 14, where cam mechanism 170 comprises traveller 171, fixed brace 172, cam surface 173 and follower 174, and further comprises springs 177.

It will be appreciated that the cam mechanism described herein may be used as part of a direction-change assembly for any of the load handling devices described in connection with FIG. 1-6, or any load handling device intended to operate with movement in two-directions on a Cartesian coordinate system.

The cam mechanisms described herein may be suitable for arrangement on each face of a load handling device as part of a direction-change assembly. For some load handling devices, it may be necessary to have a direction-change assembly only on one pair of opposed faces i.e. x-direction faces, or y-direction faces.

As discussed above in connection with FIG. 6, on some load handling devices, a direction-change assembly comprises a mechanism on each face of the load handling device for raising and lowering pairs of wheels for x-direction movement, and similarly (sometimes simultaneously) respectively lowering and raising pairs of wheels for y-direction movement.

The cam mechanisms, on each face of the load handling device may be linked by a belt, chain or other mechanical means in order to coordinate movement of the wheel pairs. It will be appreciated that vertically mirrored or horizontally mirrored cam profiles may be required for each individual face to ensure the correct coordinated movement of the wheel pairs.

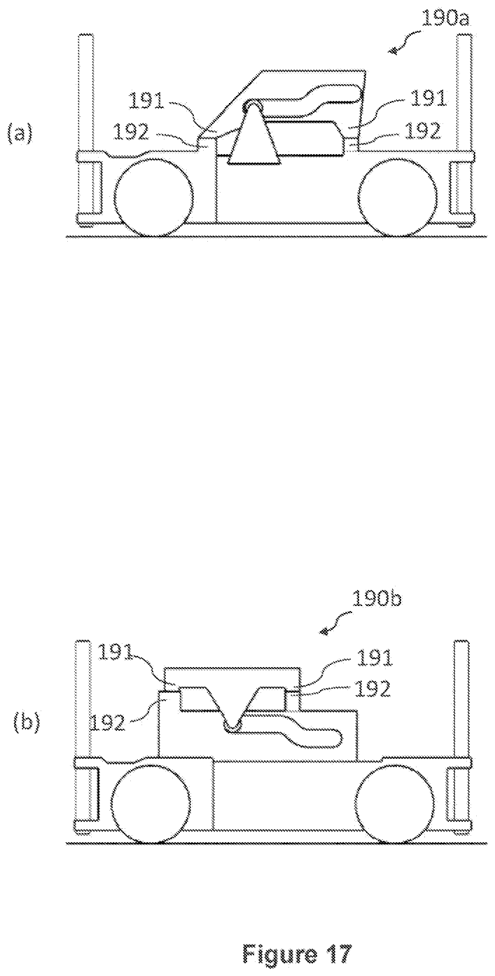

FIGS. 17a-b illustrates cam mechanisms 190a, 190b having anti-rotation feet: FIG. 17a has the cam attached to the traveller, and FIG. 17b is an inverted version of the mechanism illustrated in FIG. 17a having the cam attached to the fixed brace.

In each of FIGS. 17a and 17b, the cam mechanism comprise engagement means between the traveller and the fixed brace. As shown, the traveller has projecting anti-rotation feet 191 and the fixed brace has corresponding projecting plinths 192. As shown in FIGS. 17a and 17b, the cam mechanisms 190a, 190b are in an engaged or drive position, where the wheels are in contact with the surface. The feet 191 and the plinths 192 are in contact, whereby the plinths 192 support the anti-rotation feet 191.

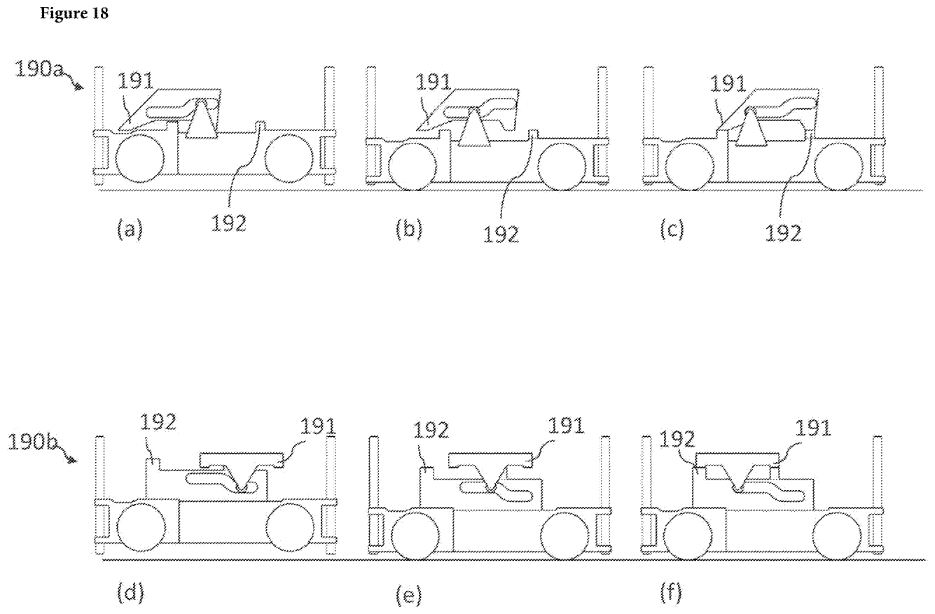

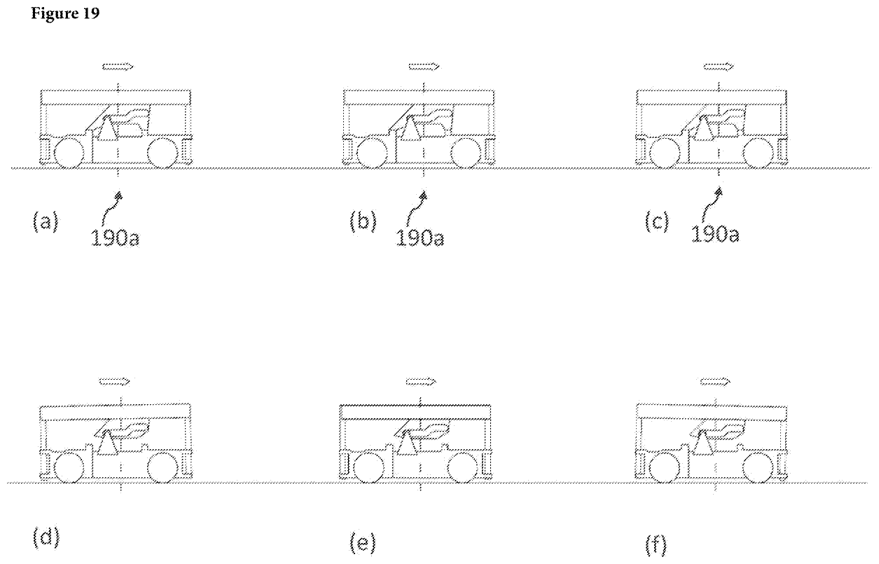

FIGS. 18a-f illustrate cam mechanisms 190a, 190b of FIG. 17 in raised (FIGS. 18a, 18d), parked (FIGS. 18b, 18e) and drive (FIGS. 18c, 19f) positions. As can be seen, the feet 191 are only engaged with the plinths 192 when in the drive position.

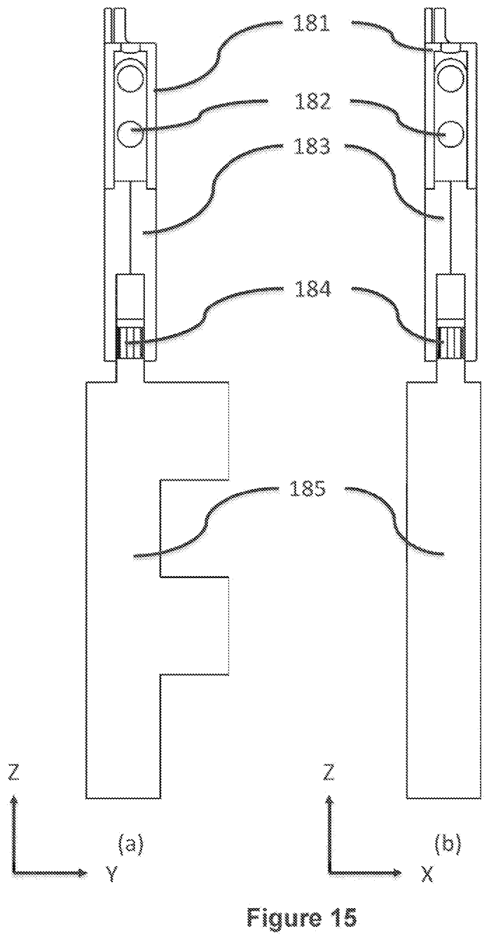

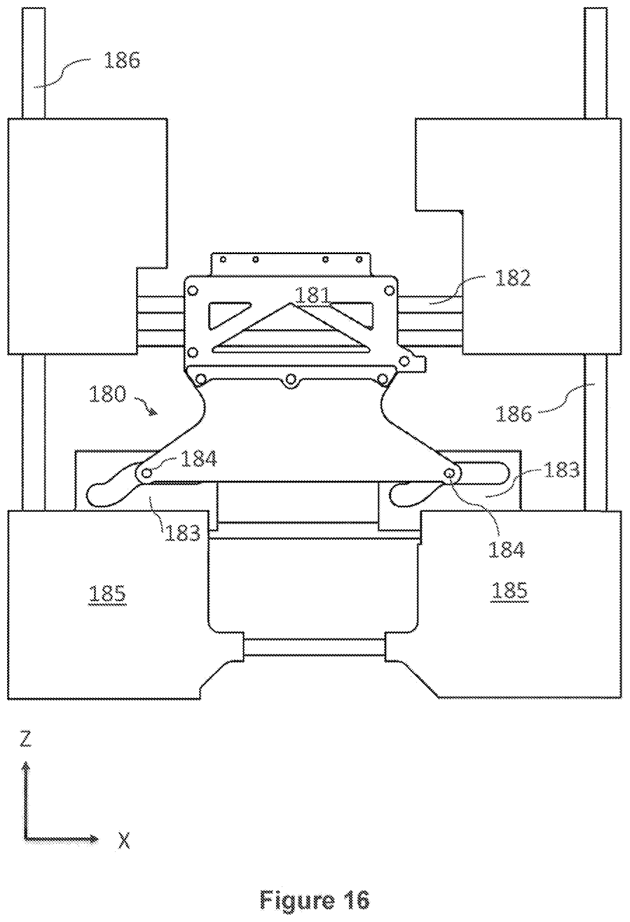

FIGS. 15 and 16 illustrate a possible wheel mount arrangement incorporating a cam mechanism direction-change assembly component, as discussed herein. The wheel mount arrangement may be suitable for any of the cam mechanisms disclosed. FIGS. 15a and 15b illustrates a side view of a cam and wheel mount arrangement and FIG. 16 illustrates a front view of the cam and wheel mount arrangement. From FIGS. 15 and 16 it will be appreciated that the cam mechanism occupies substantially a single vertical plane, and is compact.

For each face of a load handling device, a double cam mechanism 180 is mounted between the middle halo of a load handling device and the wheel chassis. The cam mechanism 180 could be any of the cam mechanisms described herein, and is not necessarily limited to a double cam mechanism as illustrated.

The traveller 181 of each cam mechanism 180 is mounted to the rods 182 which define a middle halo of the load handling device. It will be appreciated that the traveller 181 is mounted in such a way that it is free to slide or glide on the middle halo between the corner blocks. Substantially vertically below the traveller 181, is block 183 which has a slot defining the cam profile. Block 183 may be assembled in two halves, clamping a roller (or follower) 184 therebetween. Block 183 is connected directly to wheel mount blocks 185.

FIG. 15a shows the side profile for the x-direction wheel mounts, while FIG. 15b shows the side profile for the y-direction wheel mounts. It will be appreciated that the wheel mount blocks may interlock around vertical rods 186 of a load handling device skeleton.

FIGS. 19a-f illustrate a load handing device which is being driven in the direction of the arrow, to the right as shown. The cam mechanism 190a illustrated in FIGS. 19a-c is similar to that shown in FIGS. 17a, and 18a-c. Whereas the cam mechanism illustrated in figures d-f is missing the feet and corresponding plinths. In each of the illustrations, the cam mechanism is in a drive position where the wheels are engaged with the surface.

As illustrated in FIG. 19d, the load handling device is moving to the right and being accelerated. In this case, the load handling device has a tendency to tilt backward or to the left, destabilising the load handling device.

As illustrated in FIG. 19e, the load handling device is moving to the right at a constant velocity. After travelling at constant velocity there should be no tilt even without the feet. However since the load handling device has a tendency to tilt backwards when it accelerated, when the load handling device returns to a constant velocity there might be sway or oscillation in the tilting between slightly backwards and slightly forward before the load handling device stabilises.

As illustrated in FIG. 19f, the load handling device is moving to the right and being decelerated. In this case, the load handling device has a tendency to tilt forward, destabilising the load handling device.

In contrast, when a load handling device having a cam mechanism such as 190a is driven under the same conditions, the feet 191 engage with the plinths 192. The support provided by the plinths 192 to the feet 191 helps to stabilise the load handling device by making the mechanism more rigid and reducing the amount of tilt.

As illustrated in FIG. 19a, the load handling device is moving to the right and being accelerated; as illustrated in FIG. 19b, the load handling device is moving to the right at a constant velocity; and as illustrated in FIG. 19c, the load handling device is moving to the right and being decelerated. In each case the load handling device remains substantially level because the engagement of the feet with the plinths make the structure more rigid.

It will be appreciated that it is advantageous for a load handling device to remain substantially level when travelling as it will increase the precision of control, given that the load handling device may be carrying varying loads.

It will be appreciated when the cam is located on the wheel mount, the symmetry may be chosen to symmetrical when the wheels are fully down to provide the best stability when the load handling device is being driven. Consequently, the lifting may not be completely symmetrical for lifting the forward and reward wheels. It will be appreciated that the point of symmetry may be chosen to optimise other aspects of the assembly.

It will be appreciated that wheel mount subassembly will tilt as it is lifted (with a single cam), and one wheel will lift before the other potentially causing errors, potential uneven wear on other components (e.g. slide bearings between the traveller and the middle halo, or slide bearings between vertical mounting rods and corner blocks), and potentially increasing forces on specific regions of the load handling device during a direction-change operation. Accordingly, some advantages of a single cam mechanism may be realised with support or engagement means.

Where the cam is located on the traveller, regardless of whether the arrangement has a single cam or a double cam, the wheels may be lifted symmetrically because the roller is stationary relative to the driven wheels. However, a double cam on the traveller may not be feasible due to space constraints and considerations for other components.

It will be appreciated that while a load handling device operating on grid based cubic storage system, having a the grid arranged on top of the storage stacks has been described herein, the direction-change assembly, and or the cam mechanism may be applied to other autonomous or semi-autonomous devices. For example, the direction-change assembly or cam mechanism may be applied to a Kiva® or similar autonomous mobile robot (AMR)-type bot which has a lower overall height to allow positioning underneath a stack of containers or totes to lift the stack from below. It will be appreciated, that the assembly described herein is suited to this type of bot because of the relatively small vertical space required for the assembly.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that a cam mechanism can be designed for a particular application using various combinations of devices and arrangements described above. It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

1-19. (canceled)

20. A load handling device for lifting and moving storage containers stacked in a grid based storage system framework structure including a first set of parallel rails or tracks and a second set of parallel rails or tracks extending substantially perpendicularly to the first set of rails or tracks in a substantially horizontal plane to form a grid having a grid pattern with a plurality of grid spaces, wherein the grid is supported by a set of uprights to form a plurality of vertical storage locations beneath the grid for containers to be stacked between and be guided by the uprights in a vertical direction through the plurality of grid spaces, the load handling device comprising:
a skeleton including a frame defining a volume having an upper portion, a lower portion, and a middle halo between the upper portion and the lower portion;
a first set of wheels arranged on the lower part of the skeleton and a second set of wheels arranged on the lower part of the skeleton, the first set of wheels being configured and arranged to engage with a first set of parallel tracks and the second set of wheels being configured and arranged to engage with a second set of parallel tracks; and
a direction-change assembly arranged to raise or lower the first set of wheels with respect to the skeleton, and or lower or raise the second set of wheels with respect to the skeleton to engage and disengage the first and second sets of wheels with the first and second sets of parallel tracks, the direction-change assembly being located between the middle halo and the first set of wheels and or the second set of wheels, and wherein the direction-change assembly includes a cam mechanism.

21. A load handling device according to claim 20, comprising:
a wheel chassis, wherein the cam mechanism is fixed directly to the wheel chassis for mounting a pair of respective first set of wheels or second set of wheels.

22. A load handling device according to claim 20, comprising:
a fixed brace constrained by one or more mountings on the skeleton to move only in a vertical direction.

23. A load handling device according to claim 20, wherein the direction-change assembly is configured and arranged to raise or lower the first set of wheels and synchronously, and respectively, lower or raise the second set of wheels with respect to the skeleton.

24. A load handling device according to claim 20, wherein the cam mechanism comprises:
engagement means between a traveller and a fixed brace.

25. A load handling device according to claim 20, wherein the cam mechanism comprises:
a single cam arrangement, or a double cam arrangement, or a triple cam arrangement.

26. A load handling device according to claim 20, wherein the cam mechanism is configured and arranged in a single vertical plane between the middle halo and a respective pair of wheels.

27. A load handling device according to claim 20, comprising:
at least a single motor, wherein the direction-change assembly is operated by the single motor, or by more than one motor.

28. A load handling device according to claim 20, comprising:
a drive belt, wherein respective pairs of the first set of wheels and the second set of wheels are driven by the drive belt, and the cam mechanism is located within an area defined by a path of the drive belt.

29. A load handling device according to claim 20, comprising:
sensing means for determining engagement of the first set of wheels or second set of wheels with the parallel tracks.

30. A load handling device according to claim 20, comprising:
sensing means for determining malfunction or failure of the direction change assembly.

31. A load handling device according to claim 20, wherein at least a part of the cam mechanism includes 3-D printed features, and/or is substantially topologically optimised.

32. A load handling device according to claim 20, wherein the load handling device comprises:
a lifting device supported by the upper portion of the skeleton, for lifting containers into the volume.

33. A method of changing the engagement of sets of wheels with a track, of a load handling device having a skeleton including a frame defining a volume having an upper portion, a lower portion, and a middle halo between the upper portion and the lower portion; a first set of wheels arranged on the lower part of the skeleton and a second set of wheels arranged on the lower part of the skeleton, the first set of wheels being configured and arranged to engage with a first set of parallel tracks and the second set of wheels being configured and arranged to engage with a second set of parallel tracks; and a direction-change assembly arranged to raise or lower the first set of wheels with respect to the skeleton, and or lower or raise the second set of wheels with respect to the skeleton to engage and disengage the first and second sets of wheels with the first and second sets of parallel tracks, the direction-change assembly being located between the middle halo and the first set of wheels and or the second set of wheels, and wherein the direction-change assembly includes a cam mechanism, where the load handling device operates on a grid framework structure including tracks, the method comprising:
applying a force to a traveller of the direction-change assembly in a first direction F₁, causing cam mechanism to move to a first limit; or
applying a force to the traveller of the direction-change assembly in a second direction F₂, causing cam mechanism to move to a second limit.

34. A kit of parts for modular assembly of a load handling device having a skeleton including a frame defining a volume having an upper portion, a lower portion, and a middle halo between the upper portion and the lower portion; a first set of wheels arranged on the lower part of the skeleton and a second set of wheels arranged on the lower part of the skeleton, the first set of wheels being configured and arranged to engage with a first set of parallel tracks and the second set of wheels being configured and arranged to engage with a second set of parallel tracks; and a direction-change assembly arranged to raise or lower the first set of wheels with respect to the skeleton, and or lower or raise the second set of wheels with respect to the skeleton to engage and disengage the first and second sets of wheels with the first and second sets of parallel tracks, the direction-change assembly being located between the middle halo and the first set of wheels and or the second set of wheels, and wherein the direction-change assembly includes a cam mechanism, the kit comprising:
the skeleton, the first set of wheels and the second set of wheels, wherein the skeleton is configured to be mounted on the first set of wheels and the second set of wheels; and
at least one direction-change assembly including at least one cam mechanism, each cam mechanism having a traveller, a fixed brace, a follower and a cam pathway.

35. A kit of parts according to claim 34, comprising:
at least two cam mechanisms and a transfer belt.

36. A kit of parts according to claim 34, comprising:
at least one direction change motor.

37. A kit of parts according to claim 34, wherein at least one part has 3-D printed features.

38. A kit of parts according to claim 34, comprising at least one of:
a set of wheels, a drive assembly, a gripper assembly, a lifting assembly, a communications system, and/or a sensor means.
